(19) United States
(12) Patent Application Publication
(10) Pub. No.: US 2015/0056924 A1
(43) Pub. Date: Feb. 26, 2015

(54) POST-ACCIDENT NETWORK PROBE AND METHOD OF USING THE SAME

(71) Applicants: Serge Croteau, Laval (CA); Alexandre Cervinka, Verdun (CA); Alexandre Buist, Boucherville (CA); Wang Li, St-Bruno-de-Montarville (CA); Pierre-Étienne Messier, Saint-Jean-sur-Richelieu (CA); Jean-François Lambert, Montreal (CA); Glenn David Patterson, Montreal (CA)

(72) Inventors: Serge Croteau, Laval (CA); Alexandre Cervinka, Verdun (CA); Alexandre Buist, Boucherville (CA); Wang Li, St-Bruno-de-Montarville (CA); Pierre-Étienne Messier, Saint-Jean-sur-Richelieu (CA); Jean-François Lambert, Montreal (CA); Glenn David Patterson, Montreal (CA)

(73) Assignee: NEWTRAX HOLDINGS INC., Montreal, OT (CA)

(21) Appl. No.: 14/376,048

(22) PCT Filed: Jan. 21, 2012
(86) PCT No.: PCT/CA2012/000081

§ 371 Date: Oct. 9, 2014

(51) Int. Cl. E21F 11/00; H04B 7/26

(52) U.S. Cl. CPC E21F 11/00; H04B 7/26; H04W 84/00
USPC 455/66.1

(57) ABSTRACT

A post-accident network probe and a method of using such a probe are disclosed. The probe is configured to be deployed in a confined environment (e.g. an underground mine), typically after an accident has occurred, in order to establish a connection with the wireless network, or a portion thereof, located therein. The probe generally allows the rescuers to determine the position of potentially trapped miners and can allow the rescuers to have access to environment-related information collected by the network, to get vital signs information, and/or to communicate with the trapped miners. The probe can be deployed using different access methods such as bore holes (existing or new), ventilation shafts, preventive installations of probes, etc. Notably, since the probe establishes a connection with the network, the location of the probe does not have to be exactly where the miners are located as long as the miners are tracked by the network.

### CROSS-REFERENCE TO RELATED APPLICATIONS

There are no cross-related applications.

### FIELD OF THE INVENTION

The present invention generally relates to the field of wireless telecommunication networks and more particularly to the field of telecommunication networks used in confined environments (e.g. underground mines). The present invention also generally relates to the field of mine safety devices, apparatuses and/or systems.

### BACKGROUND OF THE INVENTION

Numerous underground mines are developed throughout the world. Though several safety measures are deployed to prevent accident in these mines, accidents such as cave-ins, fires, explosions, and floods do happen. When such an accident happens, the whereabouts of the miners trapped underground become unknown.

Rescue team may attempt to contact miners by drilling bore holes and dropping a telecommunication line (see for instance U.S. Pat. No. 4,254,994), but unless the trapped miners are in the immediate vicinity of one of the bore holes, these attempts to establish contact with the miners and monitor their conditions will fail and precious time will have been lost.

In some mines, underground tracking and/or monitoring networks based on a wired backbone are deployed. However, such wired networks do not typically work in many post-accident scenarios because one or more of the cables will have been cut or damaged. Even when tentatively redundant wired networks are deployed, the complexity of continuous network extensions as the mine expands leads to many areas of the mine effectively being not covered with closed loop backbone cables and signal repeaters capable of sending data in both directions. Since fixing broken cables underground from the surface via a bore hole is not realistic, the wired networks often become useless after an accident.

Another solution to allow communication between the miners, which are located underground, and the rescuers who are located above ground, is Through-The-Earth (“TTE”) technology. One example of a TTE communication system is presented in U.S. Pat. No. 7,043,195. In this example, the system comprises base stations located above ground, repeater stations located underground and mobile stations also located underground. The base stations, repeater stations and mobile stations establish a bi-directional wireless communication path through the ground. However, one drawback with TTE communication systems is that they are very power hungry. Therefore the underground repeater stations typically need to be line-powered. Hence, when an accident occurs, there is a risk that the power lines powering the repeater stations be severed. In addition, the high power consumption generally implies that any portable devices carried by the miners underground must have a large battery. Another drawback with TTE communication systems is that they operate at very low frequencies, therefore requiring very large antennas. Like for the high energy consumption, the large antenna limits the ability to miniaturize the portable devices carried by the miners, which is also a significant inconvenience. Still another drawback of TTE communication systems is that they have a limited range. In other words, depending on the type of ground materials, the depth over which the signals will penetrate can be significantly limited. Hence, for these and other reasons, TTE communication systems are not a functional solution to the problem of communicating with trapped miners after an accident.

Hence, despite ongoing research in the field, there is still a need for a simple yet functional solution to the problem of communicating with trapped miners after an accident has occurred in an underground mine.

### SUMMARY OF THE INVENTION

The shortcomings of the prior art are generally at least mitigated with a post-accident network probe that can be deployed through most bore holes or shafts (hereinafter “bore hole” or “bore holes”) in order to establish a connection with a wireless mesh tracking and/or monitoring network, or at least a portion thereof, located in a confined environment such as an underground mine.

In accordance with the principles of the present invention, the network probe generally comprises a probe head which is configured, i.e. suitably sized and shaped, to be easily inserted and slid through a bore hole, and which typically comprises all the necessary hardware and software to establish wireless communications with at least one wireless node (fixed or mobile) of the wireless network located underground. The probe head is located at the end of a communication cable which typically provides power to the probe head and a wired communication link between the probe head and a computer system (e.g. a computer, a server, etc.) located above ground.

Since the network probe is likely to be deployed several hundreds of meters into the ground, the cable is typically reinforced (internally or externally) to support its own weight, including repeater(s) and/or amplifier(s) mounted along its length, and the weight of the probe head.

When an accident does occur and miners become trapped underground, one or more bore holes will be drilled and the network probe will be deployed into these bore holes. As the probe head reaches a region of the mine where the wireless network is present, the probe head will establish a connection with the wireless network, or at least with a portion of it, if the network has been fractioned by the accident. The connection between the probe head and the wireless network, or portion of it, will provide a new backhaul link to the surface, thereby allowing environment (e.g.

temperature, gas levels, ground stability, etc.) and personnel information (e.g. locations, vital signs, etc.) collected by the wireless network to be transmitted to the surface and thus to the rescuers.

Notably, as the network probe establishes a wireless connection with the existing wireless network, or portion thereof, the location of the probe head does not have to be exactly where the trapped miners are located as in previous rescue systems. Indeed, as long as the wireless network, or portion thereof, reached by the network probe covers the area where the trapped miners are located, the exact location of the probe head with respect to the trapped miners is not critical.

The network probe in accordance with the principles of the present invention therefore generally increases the chances of locating trapped personnel (e.g. miners) in an underground confined environment (e.g. an underground mine).

Other and further aspects and advantages of the present invention will be obvious upon an understanding of the illustrative embodiments about to be described or will be indicated in the appended claims, and various advantages not referred to herein will occur to one skilled in the art upon employment of the invention in practice. The features of the present invention which are believed to be novel are set forth with particularity in the appended claims.

### BRIEF DESCRIPTION OF THE DRAWINGS

The above and other aspects, features and advantages of the invention will become more readily apparent from the following description, reference being made to the accompanying drawings in which:

FIG. 1 is a fragmentary perspective view of an embodiment of a network probe in accordance with the principles of the present invention.

FIG. 2 is a perspective exploded view of the network probe of FIG. 1.

FIG. 3 is a schematic view of a portion of an underground mine equipped with a wireless network.

FIG. 4 is a schematic view of the portion of the underground mine of FIG. 3, after an accident has occurred.

FIG. 5 is a schematic view of the portion of the underground mine of FIG. 4, during the deployment of a network probe according to a first exemplary scenario.

FIG. 6 is a schematic view of the portion of the underground mine of FIG. 4, during the deployment of a network probe according to a second exemplary scenario.

FIG. 7 is a schematic view of the portion of the underground mine of FIG. 4, during the deployment of a network probe according to a third exemplary scenario.

### DETAILED DESCRIPTION OF THE PREFERRED EMBODIMENT

A novel post-accident network probe and methods of using the same will be described hereinafter. Although the invention is described in terms of specific illustrative embodiments, it is to be understood that the embodiments described herein are by way of example only and that the scope of the invention is not intended to be limited thereby.

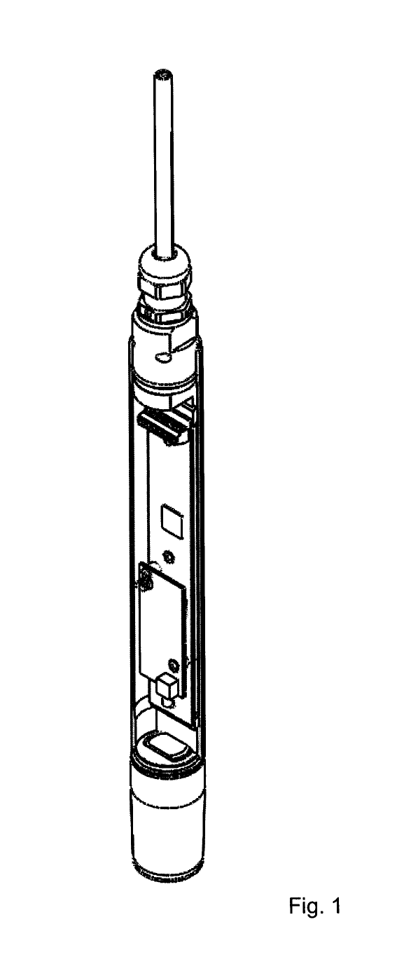

Referring first to FIG. 1, an embodiment of a network probe 10 in accordance with the principles of the present invention is depicted.

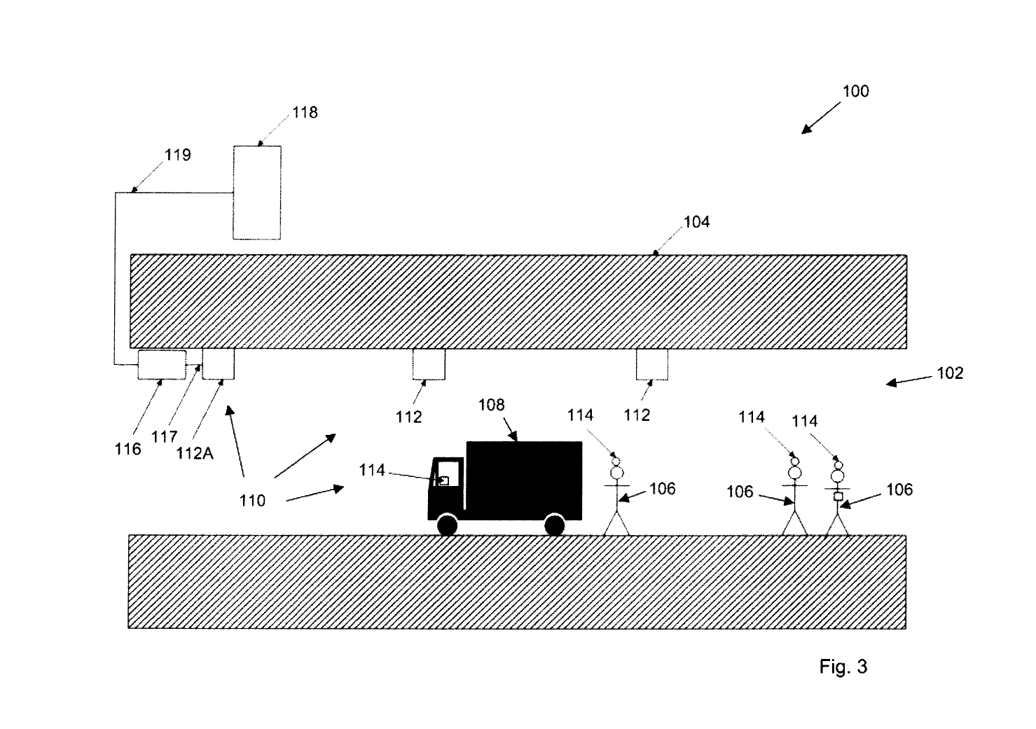

As it will be best understood below with respect to FIGS. 3 to 7, the probe 10 is configured to be lowered into a bore hole made into the ground in order to establish a new backhaul connection with a wireless network, or portion thereof, located into an underground mine, after an accident has occurred, in order to locate possibly trapped miners (or other personnel).

In that sense, the network probe 10 generally comprises two main components, a probe head 12 and a communication cable 14 connected to the probe head 12 and configured to be connected to a computer system (not shown) located at the surface.

In the present embodiment, the probe head 12 generally comprises all the necessary wireless networking hardware and software for enabling the probe head 12 to establish proper wireless communications with at least one wireless node (fixed or mobile) of the wireless network located in the underground mine. Understandably, the wireless networking hardware and software of the probe head 12 are configured for the communication protocol used by the underground wireless network.

In the present embodiment, the wireless networking hardware and software of the probe head 12 are configured for interfacing one wireless communication protocol. Still, in other embodiments, the probe head 12 could comprise several wireless networking hardware and/or software in order for the probe head 12 to be able to communicate with multiple wireless networks using different protocols.

In the present embodiment, the probe head 12 is configured to communicate with a wireless network of the type comprising battery-powered fixed wireless nodes (“fixed node” or “fixed nodes”) deployed throughout the underground mines in an ad hoc mesh network configuration, and several mobile wireless nodes (“mobile node” or “mobile nodes”) worn by the miners themselves or secured to mobile machinery. An example of such a wireless network is disclosed in International patent application no. PCT/IB2008/002262 (published under no. WO 2009/027816).

Hence, the probe head 12 essentially comprises the same wireless networking hardware and software as in a fixed node in order for the probe head 12 to be able to communicate both with other fixed nodes and/or with mobile nodes.

In other embodiments, the probe head 12 could be configured to communicate with a wireless network based on the Zigbee standard (see www.zigbee.org), which is also related to the IEEE 802.15.4 standard, or with a wireless network based on the WiFi Mesh standard (i.e. the IEEE 802.11s standard).

In still other embodiments, the probe head 12 could be configured to communicate with a wireless network wherein the fixed nodes are line-powered and possibly interconnected with data cables. Such wireless networks would still need to function if some cables are severed or if a portion thereof is isolated after an accident.

Understandably, the probe head 12, and more generally the network probe 10, could be configured to communicate with different types and configurations of wireless networks.

In the present embodiment, the wireless networking hardware of the probe head 12 generally comprises a processing unit (e.g. central processing unit, a microcontroller, etc.), memory unit(s), a modulating and demodulating (“modem”) unit, and an antenna.

The probe head 12 also comprises the necessary hardware and software for communicating with the computer system located at the surface and to which the cable 14 is connected. In the present embodiment, the probe head 12 communicates with the computer system located at the surface with a RS-232 or a RS-422 interface and therefore comprises a RS-232 or a RS-422 interface unit. Other interfaces are however possible.

As illustrated in FIG. 1, in the present embodiment, the probe head 12 is preferably elongated and slim in order for the probe head 12 to be easily inserted and slid through a bore hole.

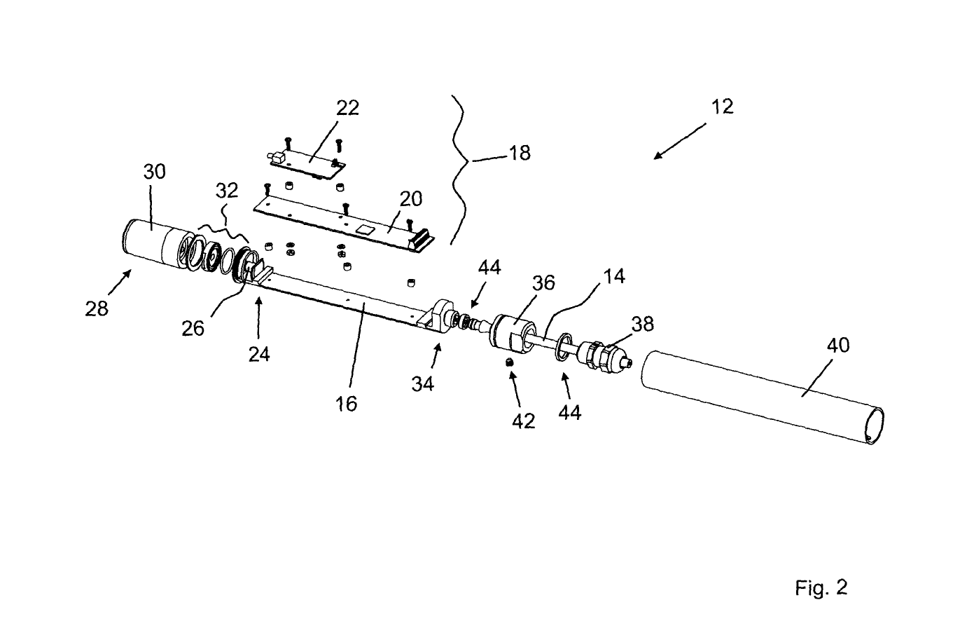

With additional reference to FIG. 2, the mechanical construction of the probe head 12 will now be described.

The probe head 12 generally comprises a main body 16 which supports the electronic hardware 18 responsible for the wireless communication with the wireless node(s) (fixed and mobile) and for the wired communication with the computer system located as the surface. In the present embodiment, the electronic hardware 18 comprises a main motherboard 20 and a RF module 22 connected thereto. The electronic hardware 18 understandably supports the appropriate software.

The free extremity 24 of the main body 16, i.e. the extremity which is not connected to the cable 14, comprises an antenna connector 26 configured to be connected to the antenna 28. In the present embodiment, the antenna 28 is mounted into a protective casing 30 which is secured to the main body 16, typically with appropriate coupling(s) and seal(s) globally referred to at 32 (see FIG. 2).

The other extremity 34 of the main body 16 is coupled to the cable 14 via a cable coupling 36 and a cable gripping element 38 configured to engage the cable coupling 36. Various rings and seals generally referred to as 44 can be mounted between the extremity 34, the coupling 36 and the gripping element 38 to insure that the cable 14 is properly secured to the main body 16.

The main body 16 is further mounted into a protective sleeve 40 which is secured thereto via a retaining screw 42. In FIG. 1, the protective sleeve 40 is shown transparently in order to see the internal components of the probe head 12. However, the protective sleeve 40 is not necessarily transparent.

Notably, as the probe head 12 is configured to be typically lowered into a bore hole made into the ground, it is most preferable that the material of the casing 30 and of the protective sleeve 40 be strong enough to absorb the numerous impacts and the more or less constant vibration to which the probe head 12 will be subjected during its descent. In the present embodiment, the casing 30 is made of polymeric materials, e.g.

plastic, and the sleeve 40 is made of metallic materials, e.g. stainless steel. Still, the material(s) of the protective sleeve 40 and more particularly of the casing 30 should not overly interfere with the wireless communication.

Still referring to FIGS. 1 and 2, as it will be best understood below, the cable 14 serves two main purposes. First, it supports the probe head 12 as the probe 10 is lowered into a bore hole. In that sense, the cable 14 is typically reinforced, for example, with metallic (e.g. steel) wires or strands or with polymeric (e.g. Kevlar™) wires or strands. It is to be understood that the probe 10 can be lowered hundreds of meters into the ground in order to reaches deep regions inside the mine. Hence, it is important that the cable 14 can support its own weight, including the weight of the probe head 12 and, if any, the weight of repeaters/amplifiers mounted along the cable 14.

Second, the cable 14 provides a wired communication path between the probe head 12 and the computer system located at the surface. Hence, depending on the communication protocol used between the probe head 12 and the computer system, the cable 14 will comprise the appropriate physical communication channel, for instance, a coaxial cable, an optical fiber, a twisted pair of wires, etc. Also, depending on the communication protocol used between the probe head 12 and the computer system, the cable 14 may further comprise power lines in order to provide power to the electronic hardware 18 of the probe head 12.

As the probe 10 might be deployed into bore holes hundreds of meters into the ground, repeaters and/or amplifiers (not shown) may be mounted along the length of the cable 14 in order to amplify the signals travelling between the probe head 12 and the computer system.

In the present embodiment, the cable 14 is a unitary structure which integrates, in a single cable, both the physical communication channel and the reinforcement elements. However, in other embodiments, the cable 14 could be an assembly of a physical communication channel cable (e.g. a coaxial cable, an optical fiber cable) and of one or more reinforcement cables (e.g. a steel cable). In other words, in such embodiments, the reinforcement cable(s) would be external to the communication cable and would be secured thereto.

In some other embodiments of the network probe 10, the probe head 12 could further comprise sensors such as gas sensors, heat sensors, humidity sensors, etc. in order to obtain environmental data from the area reached by the probe head 12, camera(s) and/or microphone(s) in order to obtain visual and/or auditory information about the area reached by the probe head 12, and/or light(s) and/or speaker(s) to provide visual and/or auditory signals to the trapped miners located in the vicinity of the area reached by the probe head 12.

In still some other embodiments of the network probe, the probe head could comprise only the antenna and possibly an amplifier. The cable (e.g. a coaxial cable) would be connected, at its other extremity, to the proper wireless networking hardware which could be distinct of or integrated with the computer system located at the surface.

Referring now to FIGS. 3 to 7, the use and deployment of the network probe 10 will be explained.

Referring first to FIG. 3, a schematic illustration of an underground mine operating under normal conditions is depicted.

In FIG. 3, the mine 100 comprises at least one tunnel or gallery 102 located under a layer of ground (i.e. rock, earth, soil, etc.) 104. Though only one tunnel 102 is shown, it is to be understood that a typical underground mine 100 comprises a network of such tunnels 102 generally extending over several levels. Hence, the mine 100 shown in FIG. 3 has been simplified for illustrative purposes only.

As illustrated, miners 106 and machinery 108 work, operate and/or circulate in the tunnel 102.

In the present embodiment, the mine 100 is provided with a wireless network 110 which allows at least the tracking of the miners 106 and of the machinery 108. The wireless network 110 can also allow the monitoring of the environmental conditions of the mine 100 if appropriate sensors (e.g. air quality sensor, ground stability sensor, etc.) are deployed. Such sensors would be either distinct from the wireless network 110 yet in communication (wired or wireless) with it, or integrated with some of the nodes (fixed or mobile) of the wireless network 110.

The wireless network 110 typically comprises a plurality of battery-powered fixed wireless nodes 112, typically mounted near the ceiling of the tunnel 102, and a plurality of mobile wireless nodes 114, typically mounted directly to the machinery 108 or worn by the miners (e.g. in their cap light, on their vest, on their belt, etc.).

The fixed nodes 112 are configured to communicate wirelessly between each other such as to form an ad hoc mesh network. The fixed nodes 112 are also configured to communicate wirelessly with the mobile nodes 116, typically for tracking and/or monitoring purposes.

As illustrated in FIG. 3, one of the fixed nodes 112, referred to as 112A, is directly connected to a gateway 116 by wires 117, and the gateway 116 is further connected to a computer system 118 (e.g. a computer, a laptop, a server, etc.) located as the surface via a backhaul cable 119. The gateway 116 is generally configured to format and transmit the data (e.g. tracking data, monitoring data, environment data, etc.) collected by the fixed nodes 112 to the computer system 118 located at the surface. Normally, an operator monitors the data, which are displayed on the computer system 118, to make sure that the mine 100 operates normally.

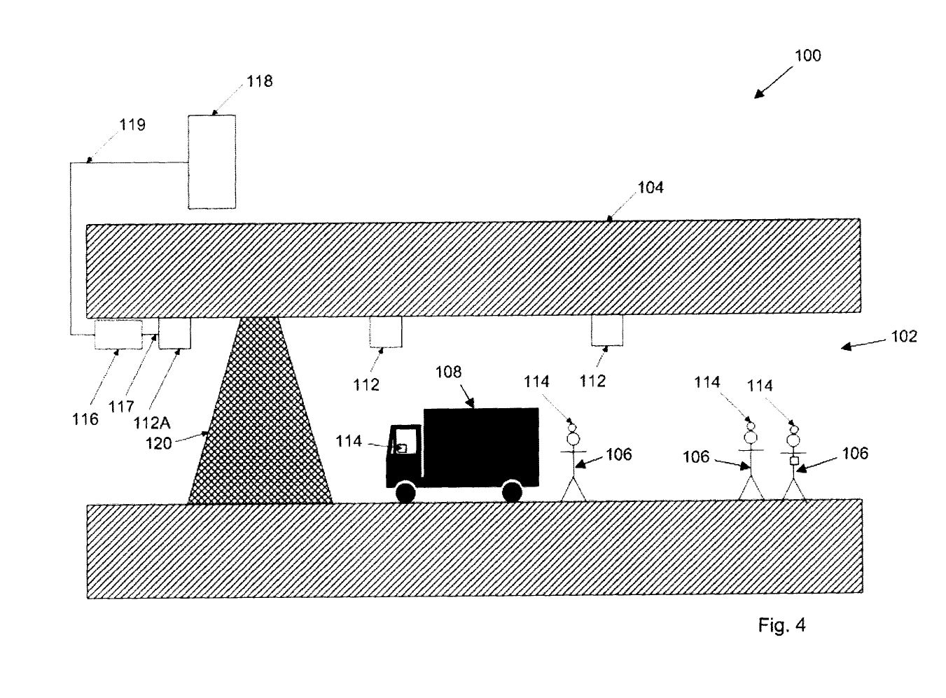

Referring now to FIG. 4, an accident, i.e. a cave-in 120, occurs within the tunnel 102 and the wireless network 110 is fractioned, i.e. a portion of the network 110 becomes isolated. Indeed, due to the cave-in 120, the fixed nodes 112 are no longer able to communicate with the fixed node 112A which is connected to the gateway 116. However, the isolated fixed nodes 112 are still able to communicate with each other and with the mobile nodes 114 located within their range.

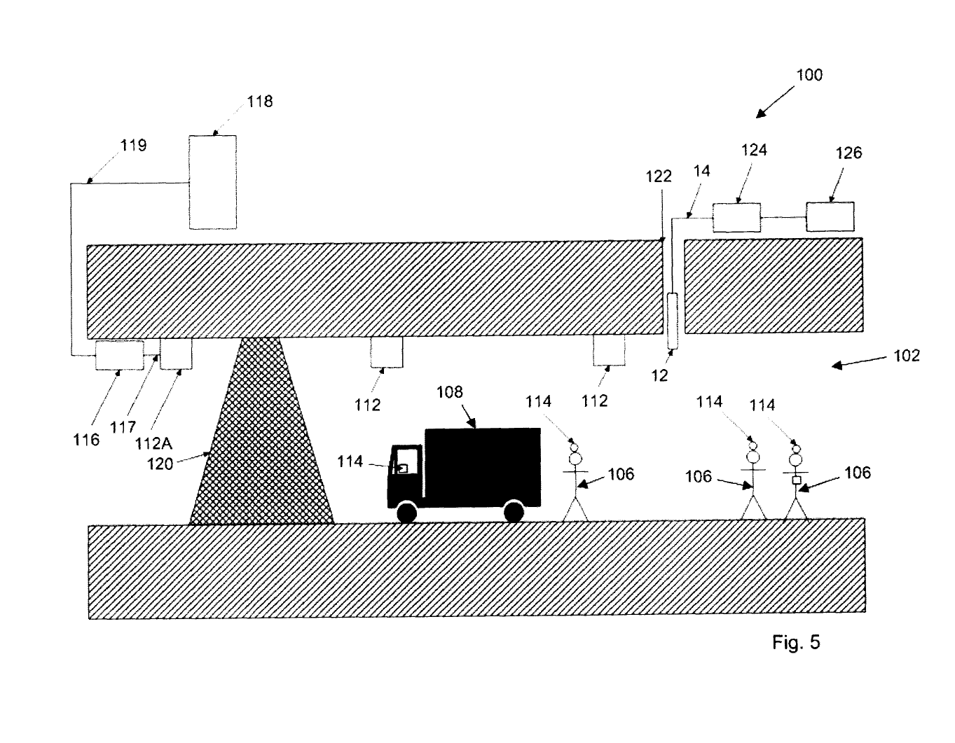

Referring now to FIGS. 5, 6 and 7, in accordance with the principles of the present invention, in order to locate the trapped miners 106, a bore hole 122 is drilled into the ground 104 in order to reach the tunnel 102. Then, a network probe 10 is lowered into the bore hole 122 until the probe head 12 reaches the tunnel 102.

As the probe head 12 reaches the tunnel 102, it will try to establish a communication with at least one fixed node 112, typically the nearest, and/or with at least one mobile node 114.

If the probe head 12 succeeds in establishing communication with a fixed node 112, the probe head 12 will be able to retrieve data (e.g. tracking data, monitoring data, environment data, etc.) collected by all the fixed nodes 112 still communicating with each other, and then to forward retrieved data to the surface via the cable 14.

If the probe head 12 reaches an area where there are no fixed nodes 112 but where one or more mobile nodes 114 are present, the probe head 12 will establish communication with the one or more mobile nodes 114 within its range, will collect data (e.g. tracking data, monitoring data, etc.) from the one or more mobile nodes 114, and will transmit the data back to the surface via the cable 14.

In any case, as the data reach the surface, rescuers will be able to ascertain whether miners 106 and/or machinery 108 are located in the area reached by the probe head 12, and will therefore be able to launch rescue efforts in this area if necessary.

In addition, if sensors are deployed within the mine 100, the rescuers will be able to determine the environmental conditions of the mine 100 in the area reached by the probe head 12. Furthermore, depending on the communication capabilities of the wireless network 110, bi-directional communication (e.g. text messages) between the trapped miners 106 and the rescuers might be possible, thereby allowing further information as to the whereabouts of the trapped miners to be gathered by the rescuers.

In the scenario of FIG. 5, the cable 14 of the probe 10 is connected to a mobile gateway 124 which is connected to a mobile computer system 126 such as a laptop computer. This scenario is likely to occur when the network of tunnels 102 of the mine 100 extends over a wide area and when the tunnel 102 where the accident has happened is far from the operating quarters of the mine 100.

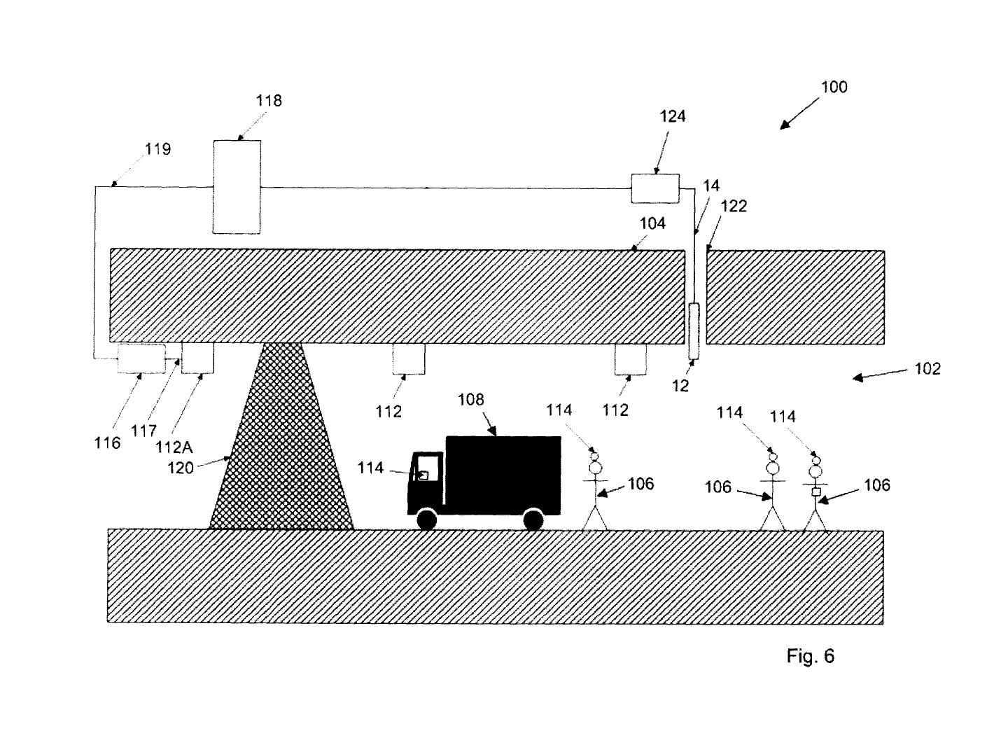

In the scenario of FIG. 6, the cable 14 is still connected to a mobile gateway 124 but the mobile gateway 124 is connected to the main computer system 118. This scenario is more likely to occur when the accident happens nearer the operating quarters of the mine 100, allowing the possibility of a direct connection between the mobile gateway 124 and the main computer system 118.

Notably, in both the scenarios of FIGS. 5 and 6, the probe head 12 reaches an area where both fixed nodes 112 and mobile nodes 114 are within the communication range of the probe head 12. Hence, in these two scenarios, the probe head 12 can communicate directly with both the fixed nodes 112 and the mobile nodes 114. Understandably, these are generally best case scenarios as the probe head 12 directly reaches the trapped miners.

However, in most scenarios, due to the sheer size of underground mines, the probe head 12 rarely directly reaches the trapped miners.

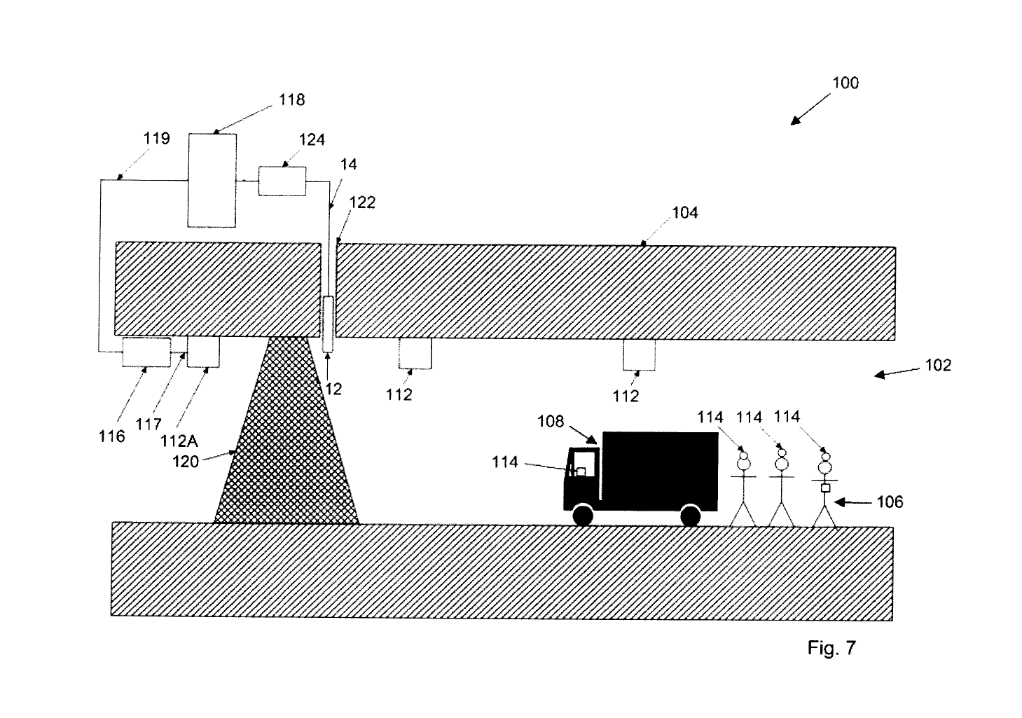

FIG. 7 illustrates such a scenario. Indeed, in the scenario of FIG. 7, the probe head 12 does not reach an area where mobile nodes 114 are within its direct communication range since the mobile nodes 114 are too far. However, and importantly, the mobile nodes 114 are still in communication with the nearest fixed node 112 and this fixed node 112 is also in communication with the other fixed nodes within the fractioned portion of the wireless network 110, i.e. the fraction of the wireless network 110 isolated by the cave-in 120.

In FIG. 7, as the probe head 12 reaches an area where at least one fixed node 112 of the fractioned portion of the wireless network 110 is within its communication range, the probe head 12 will be able to retrieve data (e.g. tracking data, monitoring data, etc.) collected by all the fixed nodes 112 of the fractioned portion of the wireless network 110, and will thus be able to retrieve the tracking data collected by the fixed node 112 with which the mobile nodes 114 are communicating.

Hence, in the scenario of FIG. 7, even if the probe head 12 does not reach an area where mobile nodes 114 are within its direct communication range, the probe head 12 will still be able to retrieve tracking data regarding these mobiles nodes 114, and thus regarding the trapped miners 106 (or machinery 108) to which these mobile nodes 114 are associated. Consequently, the probe head 12 can retrieve valuable mobile nodes 114 tracking data even if the mobile nodes 114 are not within the direct communication range of the probe head 12.

Understandably, the scenarios described above are for the purpose of illustrating how the present embodiment of the network probe 10 is to be deployed and used. Other deployment scenarios, some based on the use of different probes, are understandably possible.

As the skilled addressee will understand, the network probe in accordance with the principles of the present invention generally allows rescuers to more easily find trapped miners when an accident occurs in an underground mine equipped with a wireless network. In addition, as the network probe in accordance with the principles of the present invention establishes communication with the wireless network (fixed nodes and/or mobile nodes) and not with the miners themselves, the exact location of the probe head with respect to the trapped miners is not critical as long as the wireless network, or the portion thereof, reached by the network probe covers the area where the trapped miners are located.

Notably, even though the present embodiment of the network probe 10 has been described in the context of underground mines, it is to be understood that a network probe 10, in accordance with the principles of the present invention, could be used in other contexts where it is necessary to reach confined underground areas or regions. Non-limitative examples of other underground contexts include underground tunnel networks in urban areas (e.g. subway networks, sewer networks, underground maintenance networks, etc.), underground tunnel networks in industrial complexes, underground tunnel networks in civil infrastructures, etc.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A network probe for establishing wireless communications with at least one wireless node of a wireless network deployed into a confined area, the probe comprising:
a) a probe head configured to establish the wireless communications with the least one wireless node of the wireless network and to at least retrieve data from the at least one wireless node;
b) a communication cable connected, at a first extremity, to the probe head, and connectable, at a second extremity, to a computer system, the cable being configured to transmit the data retrieved by the probe head to the computer system.

2) A network probe as claimed in claim 1, wherein the probe head comprises wireless communication hardware configured to communicate with the at least one wireless node, and wired communication hardware configured to communicate with the computer system.

3) A network probe as claimed in claim 1, wherein the wireless network comprises fixed wireless nodes and mobile wireless nodes, the fixed nodes being configured to communicate with each other and with the mobile nodes, the mobile nodes being configured to communicate with the fixed nodes.

4) A network probe as claimed in claim 3, wherein the probe head is configured as a fixed node such that the probe head is configured to communicate both with fixed nodes and with mobile nodes.

5) A network probe as claimed in claim 1, wherein the probe head further comprises at least one sensor.

6) A network probe as claimed in claim 5, wherein the at least one sensor is a gas sensor, a humidity sensor, or a temperature sensor.

7) A network probe as claimed in claim 1, wherein the probe head further comprises a microphone, a camera, a light, a speaker, or a combination thereof.

8) A network probe as claimed in claim 1, wherein the cable is reinforced with reinforcement elements.

9) A network probe as claimed in claim 1, wherein the confined area is an underground mine.

10) A network probe for establishing wireless communications with at least one wireless node of a wireless network deployed in an underground mine, the network probe comprising a probe head mounted at an extremity of a communication cable, the other extremity of the cable being connectable to a computer system, the network probe being configured to be lowered into a hole in order for the probe head to reach an area in the underground mine where at least one node of the wireless network is within a communication range of the probe head, thereby allowing the network probe to communicate with the at least one node of the wireless network, to at least retrieve data therefrom, and to transmit the data to the computer system.

11) A network probe as claimed in claim 10, wherein the probe head comprises at least an antenna.

12) A network probe as claimed in claim 11, wherein the cable comprises a coaxial communication channel.

13) A network probe as claimed in claim 11, wherein the probe head comprises an amplifier.

14) A network probe as claimed in claim 10, wherein the probe head comprises wireless communication hardware for communicating with the at least one wireless node, and wired communication hardware for communicating with the computer system via the cable.

15) A network probe as claimed in claim 10, wherein the cable is reinforced with reinforcing elements.

16) A network probe as claimed in claim 10, wherein the cable comprises at least one repeater mounted thereto.

17) A network probe as claimed in claim 10, wherein the cable comprises at least one amplifier mounted thereto.

18) A network probe as claimed in claim 10, wherein the probe head further comprises at least one sensor.

19) A network probe as claimed in claim 10, wherein the probe head further comprises a microphone, a camera, a light, a speaker, or a combination thereof.

20) A method for locating miners in an underground mine, the underground mine having deployed therein a wireless network comprising wireless nodes, the wireless nodes comprising fixed nodes mounted in the underground mine and mobile nodes mounted to the miners, the fixed nodes and the mobile nodes being configured to wirelessly communicate with each other, the method involving the use of a network probe comprising a probe head mounted at an extremity of a communication cable, the other extremity of the cable being connected to a computer system located at the surface of the underground mine, the method comprising:
a) lowering the network probe into a hole extending between the surface and an area where at least one node of the wireless network is located;
b) establishing wireless communications with the at least one node;
c) retrieving location data from the at least one node;
d) transmitting the location data to the computer system;
e) as a function of the location data, determining if at least one of the miners is located in the area.

21) A method as claimed in claim 20, wherein the hole is a bore hole drilled between the surface and the area.

22) A method as claimed in claim 20, wherein the hole is a ventilation shaft.

23) A method as claimed in claim 20, wherein the at least one node is a fixed node.

24) A method as claimed in claim 20, wherein the at least one node is a mobile node.

25) A method as claimed in claim 20, wherein the fixed nodes are configured to wirelessly communicate with each other.

26) A method as claimed in claim 20, wherein the probe head comprises at least an antenna.

27) A method as claimed in claim 26, wherein the cable comprises a coaxial communication channel.

28) A method as claimed in claim 26, wherein the probe head comprises an amplifier.

29) A method as claimed in claim 20, wherein the probe head comprises wireless communication hardware for communicating with the at least one node, and wired communication hardware for communicating with the computer system via the cable.

30) A method as claimed in claim 20, wherein the cable is reinforced with reinforcing elements.

31) A method as claimed in claim 20, wherein the miners are trapped in a portion of the underground mine which has been isolated after an accident.
